(19) United States
(12) Patent Application Publication
(10) Pub. No.: US 2009/0278003 A1
(43) Pub. Date: Nov. 12, 2009

(54) Floor engaging device for workbench

(76) Inventor: Ching Hua Chiang, Taichung (TW)

Correspondence Address: CHARLES E. BAXLEY, ESQUIRE, 90 JOHN STREET, SUITE 309, NEW YORK, NY, 10038, US

(21) Appl. No.: 12/151,412

(22) Filed: May 6, 2008

(51) Int. Cl. F16M 11/24

(52) U.S. Cl. 248/188.4

(57) ABSTRACT

A floor engaging device includes a shank having an outer thread for threadedly securing with a workbench and having an engaging member which includes a downwardly curved surface, a base includes an upper wall having an orifice for receiving the shank, and a curved surface for engaging with the curved surface of the engaging member and for allowing the shank to be tilted and inclined or adjusted relative to the base to any suitable or selected angular position. A spring biasing member or coupling device, such as a spring member may further be used for biasing the base and the shank together and thus for coupling the base and the shank together.

### BACKGROUND OF THE INVENTION

1. Field of the Invention

The present invention relates to a workbench, and more particularly to a workbench including an adjustable or tiltable floor engaging device for leveling the workbench and for allowing the workbench to be suitably supported in a horizontal plane and for preventing the workbench from being tilted or inclined relative to the floor or the supporting surface.

2. Description of the Prior Art

Typical workbenches comprise four legs or four stands for forming a rectangular and stable structure and for allowing the workbenches to be suitably or horizontally supported on the floor or the supporting surface.

For example, U.S. Pat. No. 4,909,491 to Cheng discloses one of the typical saw plateforms and workbenches also comprising four legs or four stands for suitably or horizontally supporting the typical saw plateforms and workbenches on the floor or the supporting surface.

However, the legs or the stands may not be adjusted up and down relative to the typical saw plateforms and workbenches and also may not be adjusted up and down relative to the floor or the supporting surface such that the typical saw plateforms and workbenches may not be suitably or horizontally supported on the floor or the supporting surface.

U.S. Pat. No. 5,535,766 to Edwards discloses another typical transmission service bench also comprising four legs or four stands each having a leveling screw threadedly secured to the respective legs or stands for causing the legs or stands to be lengthened or shortened and for suitably or horizontally supporting the typical service bench on the floor or the supporting surface.

However, the leveling screw may only be adjusted up and down relative to the legs or stands of the workbench and the floor or the supporting surface, but may not be adjusted and tilted or inclined relative to the service workbench and the floor or the supporting surface.

U.S. Pat. No. 6,619,348 to Wang discloses a further typical working table also comprising four legs or four stands, and four leveling-screws threadedly secured to the respective legs or stands for causing the legs or stands to be lengthened or shortened or adjusted up and down relative to the floor or the supporting surface and for suitably or horizontally supporting the typical service bench on the floor or the supporting surface.

However, similarly, the leveling screw may only be adjusted up and down relative to the legs or stands of the workbench and the floor or the supporting surface, but may not be adjusted and tilted or inclined relative to the service workbench and the floor or the supporting surface such that the typical saw workbenches or working tables may not be suitably or horizontally supported on the floor or the supporting surface particularly when the floor or the supporting surface is uneven.

The present invention has arisen to mitigate and/or obviate the afore-described disadvantages of the conventional leveling screws for the workbenches.

### SUMMARY OF THE INVENTION

The primary objective of the present invention is to provide a workbench including an adjustable or tiltable floor engaging device for leveling the workbench and for allowing the workbench to be suitably supported in a horizontal plane and for preventing the workbench from being tilted or inclined relative to the floor or the supporting surface.

In accordance with one aspect of the invention, there is provided a floor engaging device for a workbench comprising a shank including an outer thread formed on an upper portion of the shank for threadedly securing with the workbench and for causing the shank to be adjusted up and down relative to the workbench, the shank including an engaging member extended outwardly from the shank and having a downwardly curved surface provided on a lower portion of the engaging member, and the shank including a lower portion, a base including an upper wall having an orifice for receiving the shank, and including a curved surface formed in the upper wall and formed around the orifice of the upper wall of the base for engaging with the curved surface of the engaging member and for allowing the shank to be tilted and inclined relative to the base, and a coupling device for coupling the base and the shank together and for allowing the shank and the workbench to be suitably tilted and inclined and adjusted relative to the base to any suitable or selected angular position.

The coupling device includes a spring member engaged between the shank and the base for biasing the base and the shank together. The coupling device includes a retaining ring attached to the lower portion of the shank for engaging with the spring member and for forcing the spring member to engage with the upper wall of the base.

The retaining ring includes a bore formed therein for receiving the shank and at least one flap extended from the retaining ring for engaging with the shank and for attaching the retaining ring to the lower portion of the shank.

The shank includes a peripheral groove formed in the lower portion of the shank for engaging with the flap of the retaining ring and for securing the retaining ring to the shank. The base includes a pad attached to a lower portion of the base for engaging with a supporting surface.

The engaging member of the shank is preferably includes a non-circular cross section, such as a hexagonal cross section for being engaged with a driving tool and for allowing the shank to be rotated relative to the workbench with the driving tool and thus for allowing the workbench and the shank to be suitably adjusted relative to the base with the driving tool.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a floor engaging device for a working table or workbench in accordance with the present invention;

FIG. 2 is a partial cross sectional view of the floor engaging device illustrating the operation of the floor engaging device for the working table or workbench;

FIG. 3 is an exploded view similar to FIG. 1 illustrating the other arrangement of the workbench; and

FIG. 4 is a partial cross sectional view of the floor engaging device as shown in FIG. 3.

### DETAILED DESCRIPTION OF THE PREFERRED EMBODIMENT

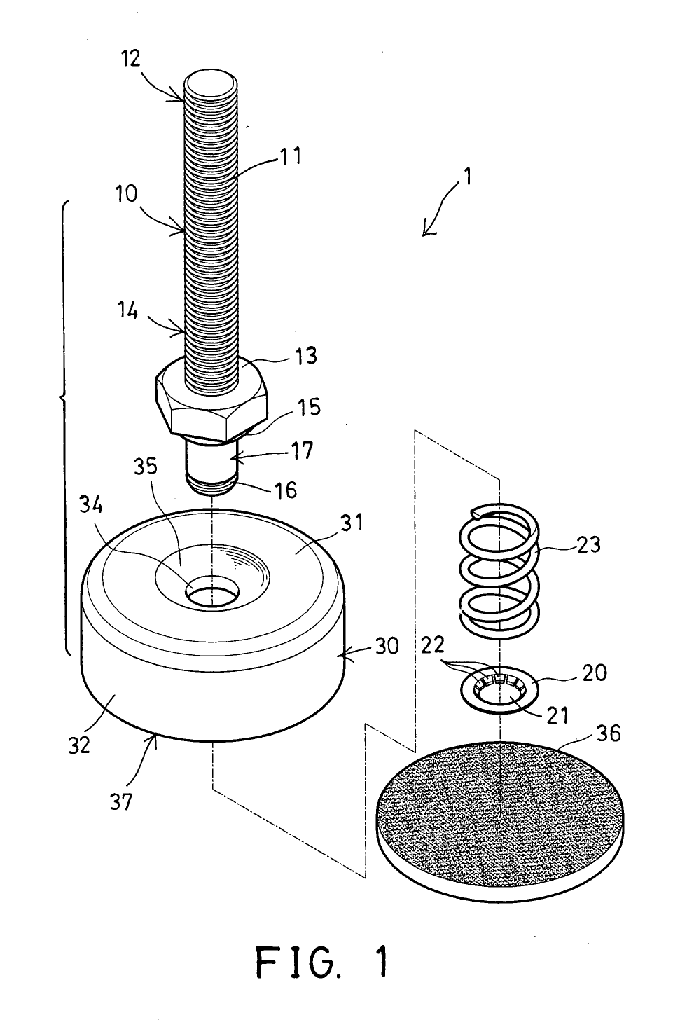

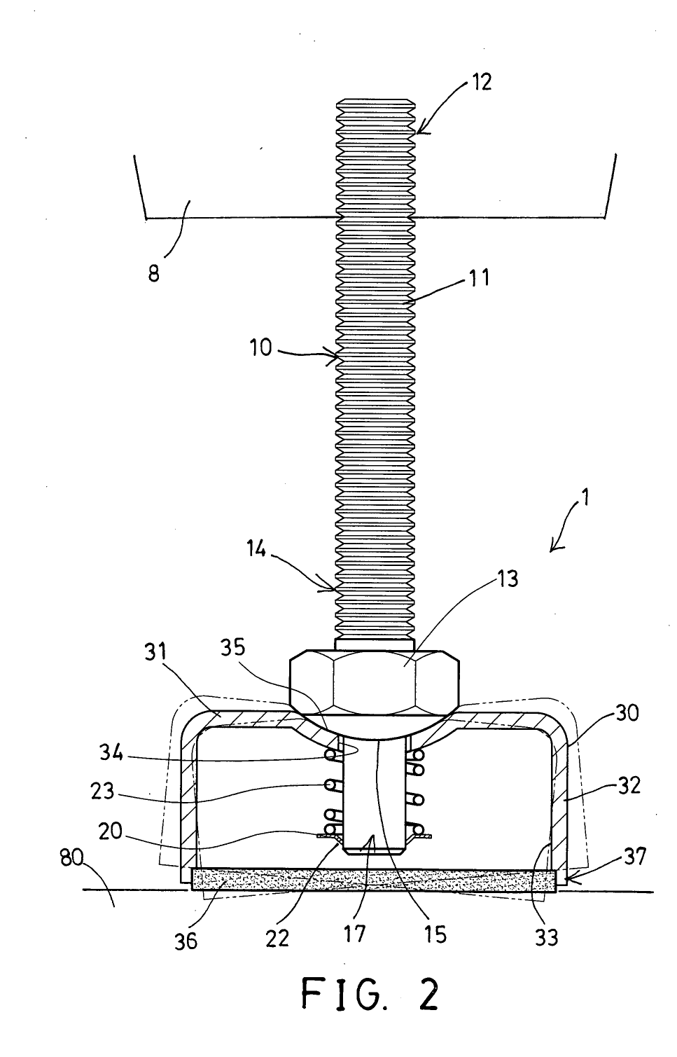

Referring to the drawings, and initially to FIGS. 1 and 2, a workbench 8 (FIG. 2) in accordance with the present invention may comprise three or more (such as four) floor engaging devices 1 attached to the four legs or stands or the four corner areas of the workbench 8 for causing the legs or stands or the four corner areas of the workbench 8 to be lengthened or shortened and/or to be adjusted up and down relative to the legs or stands or the corner areas of the workbench 8 and the floor or the supporting surface 80, and for suitably or horizontally supporting the workbench 8 on the floor or the supporting surface 80.

The floor engaging devices 1 each include a stem or shank 10 having an outer thread 11 formed or provided on the upper portion 12 of the shank 10 for threadedly securing to the respective legs or stands or the corner areas of the workbench 8 and for causing the shank 10 to be lengthened or shortened and/or to be adjusted up and down relative to the legs or stands or the corner areas of the workbench 8 and the floor or the supporting surface 80. The shank 10 includes a bulge or swelling or engaging member 13 extended radially and outwardly from the lower or middle portion 14 of the shank 10 and having a non-circular cross section, such as a hexagonal cross section for being engaged with a driving tool (not shown) and for allowing the shank 10 to be rotated relative to the workbench 8 with the driving tool.

The shank 10 further includes a downwardly curved protrusion or surface 15 extended or protruded or curved downwardly from the lower or bottom portion of the engaging member 13, and includes a peripheral groove 16 formed in the lower or bottom portion 17 thereof for attaching or securing a clamping or retaining ring 20, in which the retaining ring 20 includes a bore 21 formed therein for receiving the shank 10 and having one or more bent portions or blades or flaps 22 extended inwardly and downwardly for engaging with the peripheral groove 16 of the shank 10 and for attaching or securing the retaining ring 20 to the lower or bottom portion 17 of the shank 10 and for attaching or retaining a spring member 23 on the shank 10 and between the engaging member 13 and the retaining ring 20.

The floor engaging device 1 further includes a base 30 having an upper wall 31 and a peripheral wall 32 for forming or defining a chamber 33 within the base 30, and the base 30 includes an orifice 34 formed in the center portion of the upper wall 31 for rotatably and slidably receiving the shank 10 and for allowing the shank 10 to be moved or adjusted up and down relative to the base 30. The base 30 further includes a concave or curved recess or downwardly or inwardly curved surface 35 also formed in the center portion of the upper wall 31 and/or formed around the orifice 34 for engaging with the downwardly curved engaging member 13 and for allowing the shank 10 to be tilted or inclined relative to the base 30 and the floor or the supporting surface 80, and thus for allowing the workbench 8 to be suitably or horizontally supported on the floor or the supporting surface 80 particularly when the floor or the supporting surface 80 is uneven.

It is preferable that a pad 36 is further provided and attached or secured to the lower or bottom portion 37 of the base 30 and is preferably made of plastic, rubber, or other synthetic materials, and may further be provided or formed with various three-dimensional or spatial patterns (not shown) for increasing the frictional force or engagement with the floor or the supporting surface 80 and for preventing the base 30 from sliding or moving relative to the floor or the supporting surface 80. It is preferable that, as shown in FIG. 2, the spring member 23 is engaged between the upper wall 31 of the base 30 and the retaining ring 20 for biasing the engaging member 13 of the shank 10 toward or to engage with the inwardly curved surface 35 of the base 30 and for suitably coupling the base 30 and the shank 10 together.

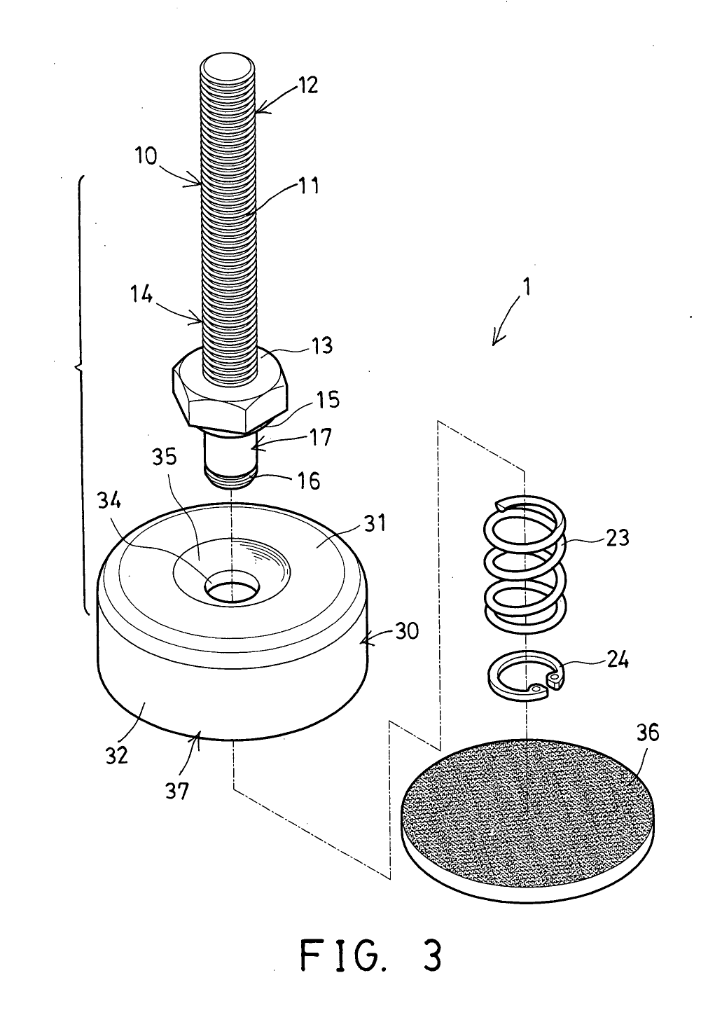

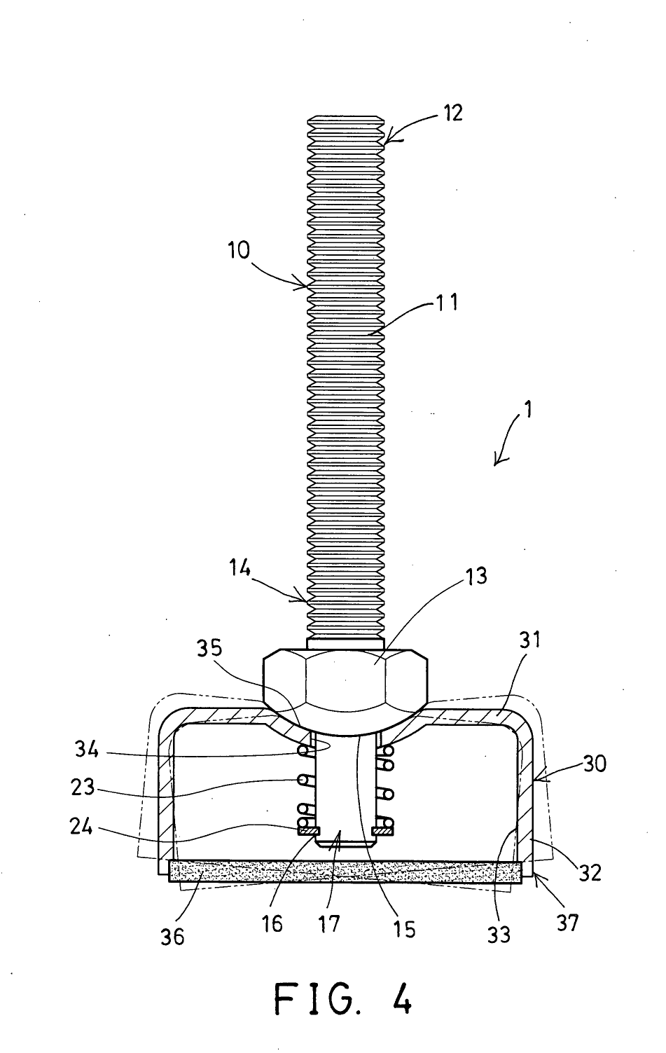

Alternatively, as shown in FIGS. 3 and 4, the clamping or retaining ring 24 may also be selected from the other clamping or retaining rings 24 which may also be engaged with the peripheral groove 16 of the shank 10 and which may also be attached or secured to the lower or bottom portion 17 of the shank 10 for suitably attaching or retaining the spring member 23 on the shank 10 and for suitably attaching or retaining the spring member 23 between the upper wall 31 of the base 30 and/or the engaging member 13 and the retaining ring 20 and for allowing the engaging member 13 of the shank 10 to be biased or forced toward or to engage with the inwardly curved surface 35 of the base 30.

In operation, as shown in FIGS. 2 and 4, the base 30 may be frictionally and stably engaged with and supported on the floor or the supporting surface 80 with the pad 36, and the sliding engagement between the downwardly curved protrusion or surface 15 of the engaging member 13 of the shank 10 and the inwardly curved surface 35 of the base 30 allows the shank 10 and the workbench 8 to be tilted or inclined or adjusted relative to the base 30 and the floor or the supporting surface 80, and thus for allowing the workbench 8 to be suitably or horizontally supported on the floor or the supporting surface 80 particularly when the floor or the supporting surface 80 is uneven. The spring member 23 may thus be formed and acted as a spring biasing means or coupling means for coupling the base 30 and the shank 10 together.

Accordingly, the workbench in accordance with the present invention includes an adjustable or tiltable floor engaging device for leveling the workbench and for allowing the workbench to be suitably supported in a horizontal plane and for preventing the workbench from being tilted or inclined relative to the floor or the supporting surface.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A floor engaging device for a workbench comprising:
a shank including an outer thread formed on an upper portion of said shank for threadedly securing with the workbench and for causing said shank to be adjusted up and down relative to the workbench, said shank including an engaging member extended outwardly from said shank and having a downwardly curved surface provided on a lower portion of said engaging member, and said shank including a lower portion,
a base including an upper wall having an orifice for receiving said shank, and including a curved surface formed in said upper wall and formed around said orifice of said upper wall of said base for engaging with said curved surface of said engaging member and for allowing said shank to be tilted and inclined relative to said base, and
means for coupling said base and said shank together.

2. The workbench as claimed in claim 1, wherein said coupling means includes a spring member engaged between said shank and said base for biasing said base and said shank together.

3. The workbench as claimed in claim 2, wherein said coupling means includes a retaining ring attached to said lower portion of said shank for engaging with said spring member and for forcing said spring member to engage with said upper wall of said base.

4. The workbench as claimed in claim 3, wherein said retaining ring includes a bore formed therein for receiving said shank and at least one flap extended from said retaining ring for engaging with said shank and for attaching said retaining ring to said lower portion of said shank.

5. The workbench as claimed in claim 3, wherein said shank includes a peripheral groove formed in said lower portion of said shank for engaging with said at least one flap of said retaining ring and for securing said retaining ring to said shank.

6. The workbench as claimed in claim 1, wherein said base includes a pad attached to a lower portion of said base for engaging with a supporting surface.

7. The workbench as claimed in claim 1, wherein said engaging member of said shank includes a non-circular cross section.

8. The workbench as claimed in claim 1, wherein said engaging member of said shank includes a hexagonal cross section.
